(19) United States
(12) Patent Application Publication
(10) Pub. No.: US 2018/0244389 A1
(43) Pub. Date: Aug. 30, 2018

(54) TRANSPORT TOOL SYSTEM FOR DRONE WITH SEPARATE CONTROL

(71) Applicant: Nolan M. Herlocker, Cedar Rapids, IA (US)

(72) Inventor: Nolan M. Herlocker, Cedar Rapids, IA (US)

(21) Appl. No.: 15/902,684

(22) Filed: Feb. 22, 2018

Related U.S. Application Data
(60) Provisional application No. 62/461,968, filed on Feb. 22, 2017.

(51) Int. Cl. B64D 1/08; B66C 1/42; B64C 39/02

(52) U.S. Cl. CPC B64D 1/08; B66C 1/42; B64C 2201/128; B66C 1/425; B64C 2201/024; B64C 39/024

(57) ABSTRACT

A transport tool system having a tool attached to a drone. The drone has a first control system that operates the tool. Preferably the tool is detachable from the drone and is adapted to capture, transport, and release an object to a desired location.

### CROSS REFERENCE TO RELATED APPLICATION

This application claims the benefit of U.S. Provisional Application No. 62/461,968 filed Feb. 22, 2017.

### BACKGROUND OF THE INVENTION

This invention is directed toward a drone with a detachable tool system and more particularly a drone with a detachable tool system having a separate and independent control system.

Drones are well-known in the art. Presently drones are used in a number of ways including search and rescue, inspections, security, surveillance, science and research, aerial photography and video, surveying/GIS, unmanned cargo systems, and the like. To perform these functions the drones are either built specifically to perform the function, or are hardwired within the drone. Either way, the process is expensive and the drone becomes limited in the number of applications that can be performed. Therefore, a need exist in the art for a device that addresses these deficiencies.

An objective of the present invention is to provide a transport tool system for a drone that is independently controlled.

Another object of the present invention is to provide a transport tool system where the tool is removably attached to a drone so that tools are easily exchanged.

These and other objectives will be apparent to those skilled in the art based upon the following written description, drawings, and claims.

### SUMMARY OF THE INVENTION

A transport tool system includes a tool that is removably attached to a drone directly or indirectly with a strap. The drone has a control system that controls and operates the drone and the tool has a separate and independent control system that controls the tool.

The tool is of any type that is moveable and adapted to clasp or pick-up, transport, and release an object. In one example, the tool is a moveable claw.

### BRIEF DESCRIPTION OF THE DRAWINGS

FIG. 1 is a perspective view of a transport tool system;

FIG. 2 is a side view of a tool;

FIG. 3 is an end view of a tool;

FIG. 4 is a perspective view of a tool; and

FIG. 5 is a sectional side view of a tool.

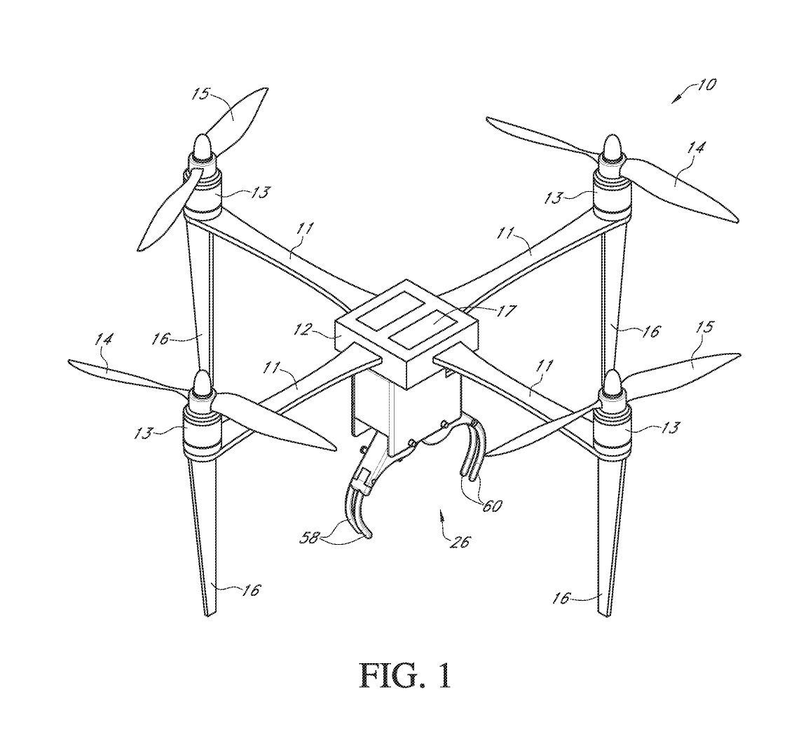

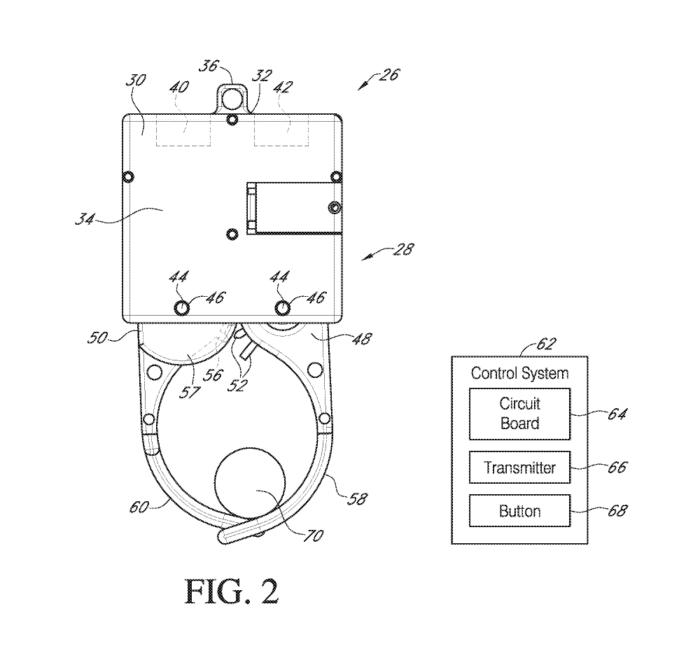

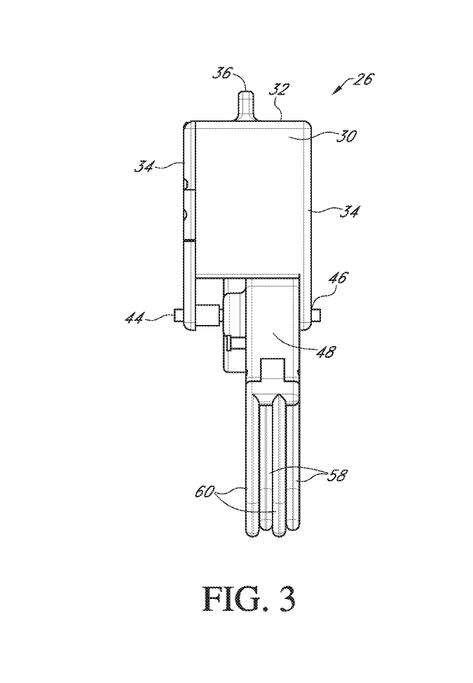

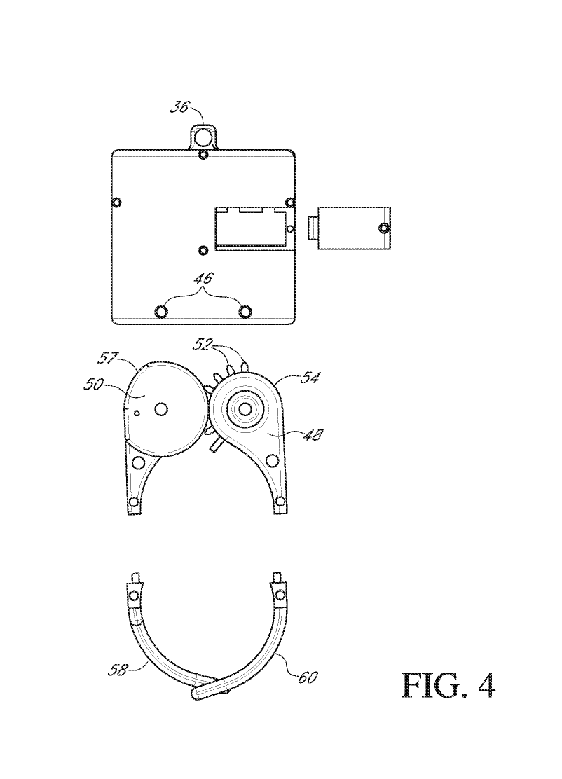

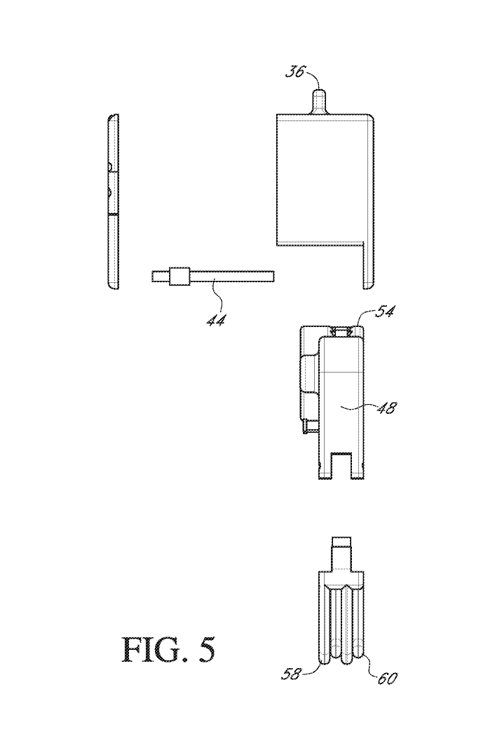

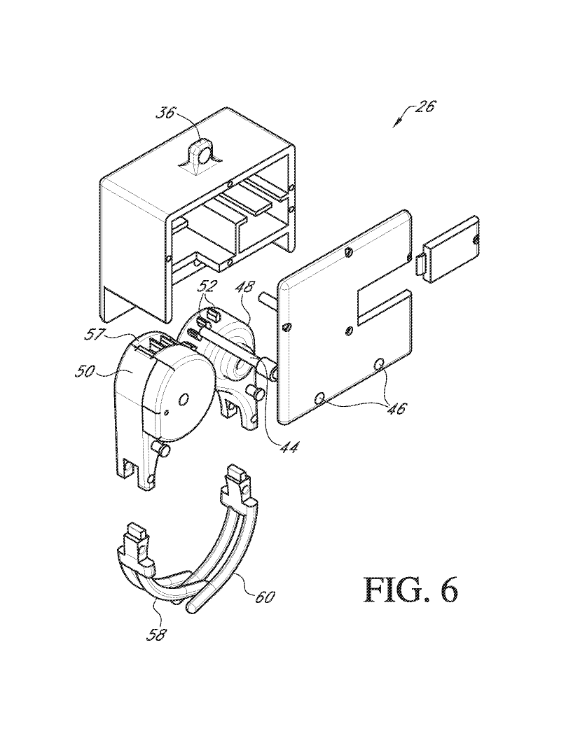

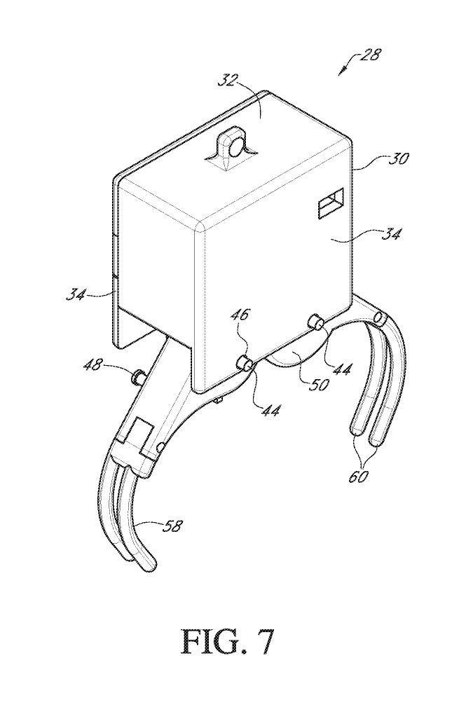

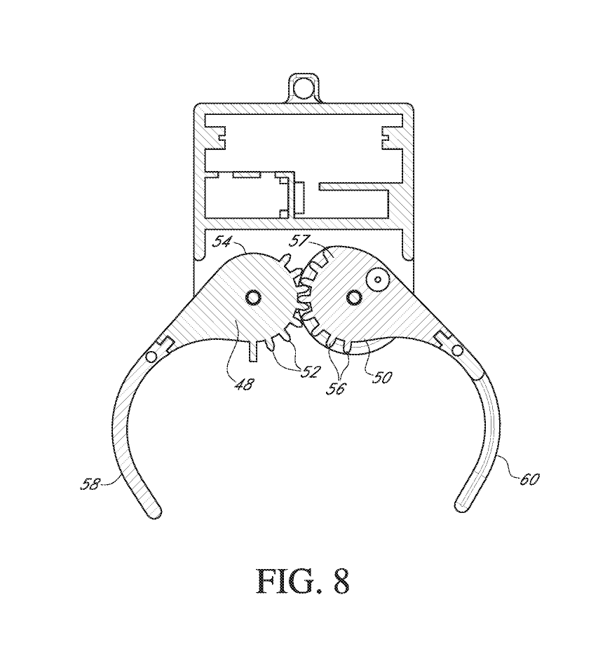

### DETAILED DESCRIPTION

Referring to the Figures, shown is an example of a drone 10. The drone is of any size, shape, and structure and in the example shown has a plurality of booms 11 extending outwardly from a main body 12. Attached to an outer end of each boom 11 is a brushless motor 13. Operatively connected to the brushless motors 13 are a pair of standard props 14 and a pair of pusher props 15. Also attached to the end of the booms 11 and extending downwardly are landing gear supports 16. Attached to the top of the main body 12 is a motor mount 17.

Removably attached to the drone 10 is a tool 26. The tool 26 is attached to the main body 12, to the landing gear supports 16 using a strap 27, or to any other part of the drone 10. The tool 26 is of any size, shape, or structure capable of performing a work function in conjunction with the operation of the drone 10. As one example, a moveable claw 28 is attached to the main body 12 of the drone 10. The claw 28 is useful in a number of ways such as transporting a rescue line to a victim who has fallen into a river or through the ice, lifting power lines, transporting safety lines to rock climbers, and the like.

The claw 28 is of any size, shape, and structure. In the example shown, the claw 28 has a c-shaped bracket 30 having a back or mounting wall 32 and a pair of parallel spaced side walls 34 that are perpendicular to and extend away from the outer edges of the back wall 32. The back wall 32 is connected to the main body 12 of the drone 10 with a screw 36 or the like. Attached to an inner surface 38 of the back wall 32 is a servo receiver 40 and replaceable or rechargeable battery 42 so that the tool 26 is independently powered.

Connected to the servo receiver 40 is at least one of a pair of rotatable pins 44 that extend through aligned openings 46 in side walls 34. Mounted about the pins 44 is a male 48 and a female 50 disc. The male disc 48 has a plurality of teeth 52 that extend radially outwardly from the outer perimeter 54 of the male disc 48. The female disc 50 has a plurality of slots 56 that extend inwardly from the outer periphery 57 of the female disc 50. The male 48 and the female 50 discs are positioned adjacent one another so that as the male disc 48 is rotated the teeth 52 are received in an aligned slot 56 of the female slot 56 causing the female disc 50 to rotate. As the male disc 48 continues to rotate, the teeth 52 are withdrawn from the aligned slot 56.

Either integral or connected to the male 48 or female disc 50 is a claw finger 58 that is preferably curved or arcuate in a direction toward the other disc. Integral or connected to the other disc, female 50 or male 48, is a pair of spaced claw fingers 60 that curve toward claw finger 58. Claw finger 58 is positioned in a plane between claw fingers 60. Alternatively claw finger 58 and 60 both include a pair of fingers that are offset in different planes to that they intersect. In addition, a spring 61 is connected to and extends between claw fingers 58 and 60 to bias the fingers toward a closed or intersecting position. The spring 63 acts as a backup safety mechanism so that if power is lost the claw 28 will not drop the object being transported.

The tool 26 is controlled by a remote control system 62 wirelessly connected to the tool 26. The remote control system 62 is of any size, shape, and structure and in a preferred example is a key fob having a circuit board 64 and connected transmitter 66 that is selectively activated with a button or switch 68.

In operation, an object 70, such as a safety line is placed between claw finger 58 and claw fingers 60. Button 68 on control system 62 is activated causing transmitter 66 to send a signal to the servo receiver 40 on the tool 26. The servo receiver 40 processes the signal and activates or rotates at least one of a pair of pins 44. As the pin rotates so does one of the discs 48 or 50. As one of the discs 48 or 50 rotate, this causes the teeth 52 to engage the slots 56 which cause the other disc 50 or 48 to rotate. As the discs 48 and 50 rotate, claw fingers 58 and 60 move toward one another capturing the object 70.

Once the object 70 is captured, the drone 10, using control unit 22, is flown to a selected location in any conventional manner which is well known to those skilled in the art.

When the drone 10 reaches the selected location the button 68 is reactivated sending a signal from the transmitter 66 to the servo receiver 40. The servo receiver processes the signal and then activates the al least one pin 44 to rotate in the opposite direction which causes discs 48 and 50 to rotate in an opposite direction such that claw fingers 58 and 60 move away from one another releasing the object 70.

While the disclosure describes the tool 26 as a claw, other tools such as a flashlight, a water deployable buoy, or the like can be used.

What is claimed is:

1. A system for transporting an object, comprising:
a drone having a first control system;
a tool connected to the drone and adapted to transport an object having a second control system; and
wherein the first control system operates the drone independently of the second control system which operates the tool.

2. The system of claim 1 wherein the tool is removably detachable from the drone.

3. The system of claim 1 wherein the tool is a moveable claw.

4. The system of claim 1 wherein the tool is connected to the drone using a strap.

5. The system of claim 1 wherein the tool is a moveable claw having first and second claw fingers adapted to capture an object.

6. The system of claim 6 wherein a spring is connected to and extends between the first and second claw fingers.
